(19) United States
(12) Patent Application Publication
(10) Pub. No.: US 2011/0154719 A1
(43) Pub. Date: Jun. 30, 2011

(54) Flea magnet (random motion flea trap)

(76) Inventor: Rex Carroll, St. Matthews, SC (US)

(21) Appl. No.: 12/930,035

(22) Filed: Dec. 27, 2010

Related U.S. Application Data
(60) Provisional application No. 61/284,730, filed on Dec. 24, 2009.

(51) Int. Cl. A01M 5/06

(52) U.S. Cl. 43/136

(57) ABSTRACT

This invention utilizes a autonomous platform disc that can move at random or in a pattern around an area in a home or yard with a lighted sticky cone/dome designed to get adult fleas to jump to it and become stuck. The trap uses motion and other lures to capture fleas safely without the use of chemicals to erradicate fleas and to the keep threat of infestations low.

### BRIEF SUMMARY OF THE INVENTION

The invention incorporates movement by a small robotic round autonomous platform that can roam around an area so as to entice fleas to jump on it. A sticky paper cone or dome then captures and traps fleas to it. This is the only flea trap or such device that is not in a fixed position. The movement is the main flea attractant, the cone has 360 degree vertical and angled sticky surface that is printed as animal hair and is backlit for attracting purposes as well. Other lures such as blue-green lights and lights with a heat signature of the same body temperature as a dog or cat (100 degrees F.) and possibly smells or sounds add to the trap's effectiveness. The movement allows unit to cover an entire room central body without the need to be close to walls or objects. The trap moves at a slow pace and stops occasionally. The various sensors and switches keep it from bumping things and if it does the additional bump switch can divert the direction. The protective cone guard or cage also acts as a bump switch. The trap can be modified and used in pens or yard spaces which also uses the natural instincts of fleas and entices them to jump up on a warm moving object to feed and nest. It's meant to capture adult fleas before they feed or breed in a safe and effective manner (non-chemical) 24 hours a day. Battery recharging systems are manual or self-returning to a charging base. The robotic base can incorporate a variety of sensing and drive systems. Sticky cones or domes can be different color patterns and variations.

### DESCRIPTION OF THE VIEWS

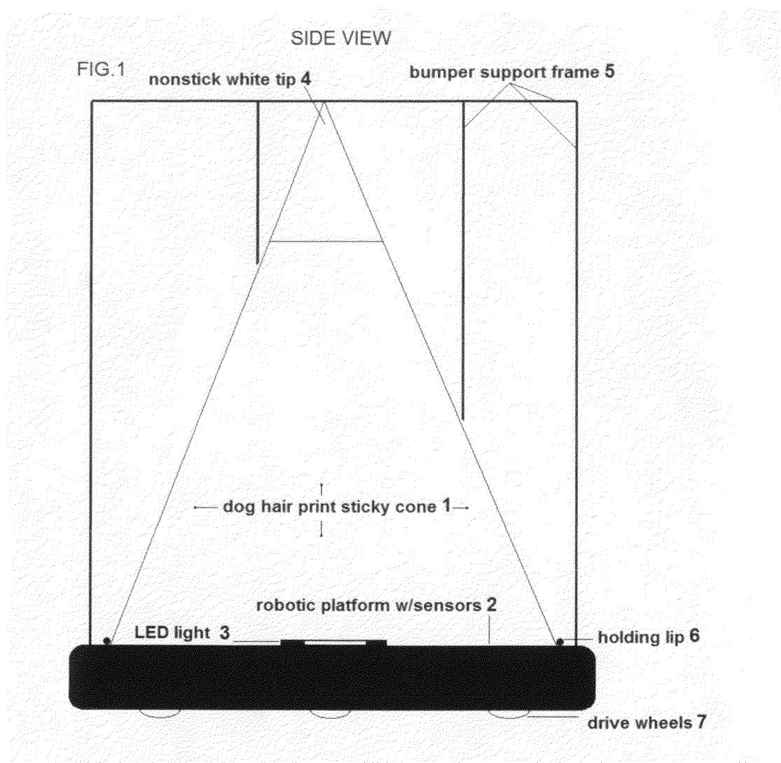

(FIG. 1) Side view: robotic platform with sticky cone and the bumper frame.

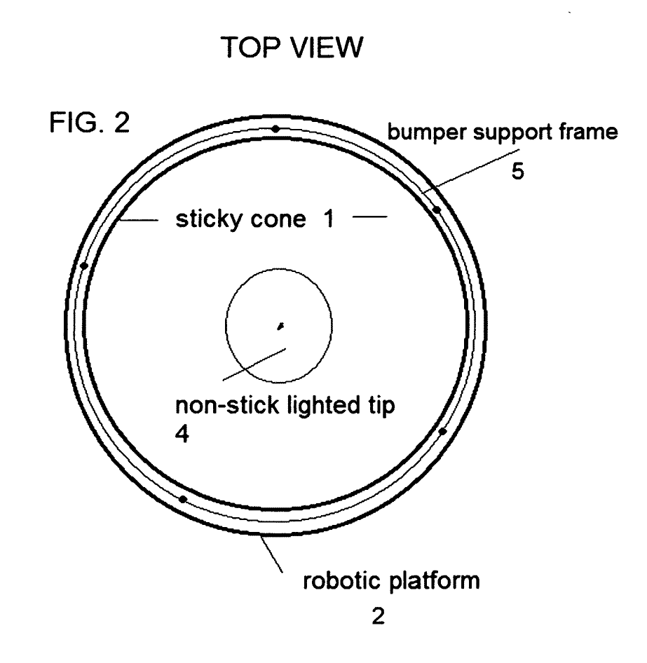

(FIG. 2) Top view: stickycone, the robotic platform and bump support outlines. Also the cone holding lip and LED light.

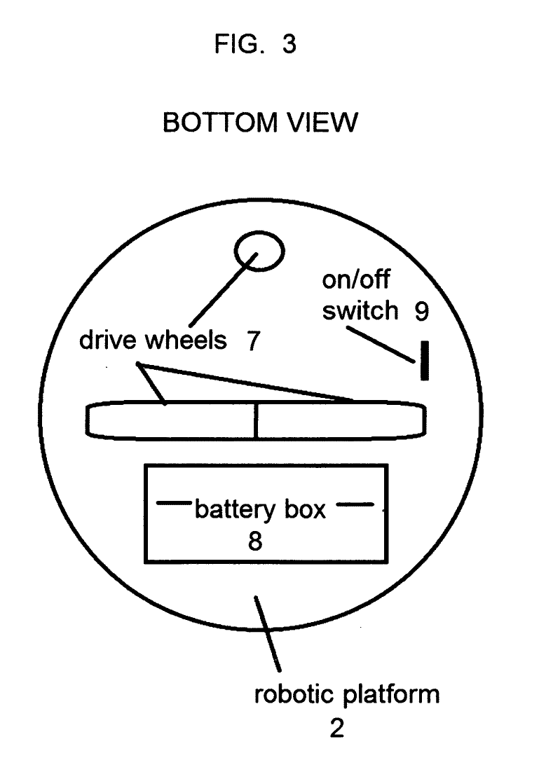

(FIG. 3) Bottom view: on/off switch and drive wheel locations are shown as well as the battery box and roundness of unit as in FIG. 2.

### DETAILED DESCRIPTION OF THE INVENTION

The invention consists of a round platform (2) that has the drive motors and drive wheel 7 attached to it. The rechargeable battery, drop edge sensor, obstacle sensor, light and thermal systems 3 and their control board are also attached. The bump support frame 5 and other switches used for directional change are mounted to the platform as well. The top cap of the platform is of various shapes and has lip 6 for a cone or dome 1 to set in for stability. The lid also can have different other sensor and light attachments for the different systems employed. The cone is a paper or composite paper shaped to provide a 360 degree vertical surface for the fleas to jump up onto. The cone 1 is coated with a sticky sap for fleas to stick to and can be printed to match an animal design. The sticky cone 1 rides atop the unit and as it moves it entices adult fleas to jump to it. The lights are blue/green and are used as a night attractant, and some giving a thermal heat signature for fleas to be able to see 3. The sensors keep the unit from going over an edge or running over or into an object. The bumper support frame 5 protects the cone or the dome from sticking to objects and also acts as a switch to the drive motor to reverse drive and back forward to a different moving direction. The top of the cone/dome can light up and backlite the sticky cone patterns and part is left dry as to be able to handle it 4. The robotic platform can be different shapes and sizes to perform uses for indoor and outdoor purposes. It can have a home base charging system where unit returns to charger after sensing a low battery or a plug in charger. This random motion flea trap uses movement, 100 degree thermal spots (dog and cat body temps.), blue-green night lights (a study showed this color best attracts fleas) to entice the pests to jump from any direction onto a vertical and inward sloping sticky surface where they stuck and cannot feed or reproduce. The units cone is easily accessed and replaced 4 as well as the battery 8. The power is manually switched on 9 or by other systems that can be used.

### LEGEND

1. sticky cone
2. robotic platform
3. LED light
4. nonstick white tip
5. bumper support frame
6. holding lip
7. drive wheels
8. battery box
9. on/off switch

1. I claim that the said invention is unique in that it is the only flea trap apparatus using a sticky surface and autonomous disc platform housing that can move around a given specific area using it's motion and other attractants to lure adult fleas to jump onto a special cone shaped sticky surface from any direction and height as to erradicate adult fleas from homes or yards in an environmentally friendly way.
